(19) United States
(12) Patent Application Publication
(10) Pub. No.: US 2004/0038169 A1
(43) Pub. Date: Feb. 26, 2004

(54) Intra-oral camera coupled directly and independently to a computer

(76) Inventors: Stan Mandelkern, Teaneck, NJ (US); David Schick, New York, NY (US); Noel Lucas, Bayport, NY (US); Daniel Michaeli, Long Island City, NY (US)

Correspondence Address: FITZPATRICK CELLA HARPER & SCINTO, 30 ROCKEFELLER PLAZA, NEW YORK, NY, 10112, US

(21) Appl. No.: 10/225,350

(22) Filed: Aug. 22, 2002

(51) Int. Cl. A61C 3/00

(52) U.S. Cl. 433/29

(57) ABSTRACT

An intra-oral dental camera is provided having a digital output which communicates directly with a computer. A handpiece is included which has a plurality of LEDs to illuminate a subject, an image sensor that generates an analog signal representing an intra-oral video image, an analog-to-digital converter that converts the analog signal into a digital signal, and a video compression circuit that compresses compressing the digital signal. A cable is connected to the handpiece that receives the compressed digital signal from the handpiece, provides the compressed digital signal to a digital port on an image processing unit and provides power from the image processing unit to the handpiece to drive the LEDs.

### BACKGROUND OF THE INVENTION

1. Field of the Invention

This invention relates generally to the field of dental cameras, and more particularly to an intra-oral dental camera system having a digital output that connects directly and independently to a computer.

2. Related Art

For many years, clinicians in the dental industry used dental mirrors to more clearly visualize and diagnose hidden areas in a patient's mouth. These mirrors remain useful in certain respects, but significant limitations exist. First, it is often difficult to visualize a dental structure using dental mirrors, because the image must be reflected into the viewer's line of sight. Second, mirrors provide a relatively small image that can be difficult to see, particularly for older practitioners. Third, providing the lighting necessary to illuminate fully the area being reflected by the mirror in order to properly visualize the dental features remains a challenge. Furthermore, it is often difficult using mirrors to communicate information to the patient or to other clinicians because the image to be visualized is dependent upon the viewer's position relative to the mirror.

In order to address these and other significant limitations associated with using mirrors to visualize and diagnose obscure areas of a patient's mouth, intra-oral cameras were introduced into the field, and are now widely used within the dental industry to enhance the practitioner's ability to view the patient's dental anatomy. Intra-oral dental cameras are also useful in providing the patient with a visual understanding of his or her clinical options.

Existing dental cameras provide advantages over dental mirrors in several respects. First, they do not require positioning towards a reflected angle. Second, they typically have built-in light sources which illuminate the area being reflected by the mirror. Third, dental cameras are also useful in obtaining a permanent record of the condition of the patient's mouth. Furthermore, they can be used as “teaching tools” to communicate information to others, since the images appear on a monitor and therefore more people than simply the dental practitioner may view their output.

Although prior art techniques are generally good for their intended purposes, several aspects of the design of existing dental cameras could be improved. For one thing, dental cameras are often utilized with a computer, which may act as a means for controlling the camera or the camera processing. Dental cameras typically consist of a hand-piece and a base station coupled to a monitor which serves as the viewing station for displaying the images. This setup offers a measure of flexibility in storing and post-processing images and may also lead to advantages in monitor and printer costs.

Integration of dental cameras with a computer is, however, often cumbersome for a number of reasons. First, the two components are not inherently compatible. Dental cameras typically output a high bandwidth analog signal, which is convenient for communication with an AV display monitor; however, an analog signal is not readily compatible with a digital computer, and for this reason specialized hardware including a lower reliability analog-to-digital converter (ADC) is typically required. Incorporating such specialized hardware into a dental camera system would result in a cumbersome base station and numerous cords for transmitting data and supplying power to the dental camera. In addition, the quality of an analog signal can be severely degraded by the significant noise present in a dental office. While the inventors of this application are aware of others who have addressed these issues for applications in other industries, the dental camera carries with it additional complexities, such as requiring power for illumination. It also carries with it significant space limitations, in that a dental camera has to be small enough to fit into the patient's mouth.

There is therefore a need for a dental camera having a more simplistic scheme which outputs a digital signal, and which does not require specialized hardware components, a cumbersome base station, and numerous cords for transmitting data and supplying power to the dental camera. In essence, then, there is a need for providing a simpler mechanism of integrating a dental camera with a computer.

Another complexity involves transmitting video data to the computer. Transmitting continuous and smooth video (i.e., NTSC and PAL standards) at the preferred pixel count requires an extremely fast data transfer rate. As an example, transmitting 8 bits of data at 30 frames per second at the standard video resolution of 640×480 pixels requires a data transfer rate of nearly 74 MBits/s. This rate is nearly seven times faster than that which can currently be achieved by, for example, the Universal Serial Bus (USB), which will be further described below.

Some products in other industries have attempted to overcome this difficulty by utilizing a high-speed data port to provide a data path between the camera and the computer's CPU, such as the Peripheral Component Interconnect (PCI) bus. The PCI bus is an internal 32-bit local bus that runs at 33 MHz and carries data at up to 133 megabtyes per second (MBps). Data transmission is effected by installing a card on this port. However, to utilize such a card, a trained technician must open the computer housing and install specially designed hardware, which is not only time consuming but in most cases invalidates the manufacturer's warranty. Furthermore, these cards can be expensive, and must be color-matched to the camera of choice. In addition, they reduce the reliability of the overall system, and in many cases cannot be installed on portable computer systems such as laptops and notebooks because these computers generally are not provided with PCI slots.

Other non-dental products employ a slower port and use data compression to reduce the amount of data. Cameras exist in industries other than the dental industry wherein communication between the camera and the computer is made by way of a commonly available and accessible digital port such as, but not limited to, the USB. The USB is a serial 12 megabit per second (Mbps) channel that can be used for peripherals. The USB is a token-based bus; that is, the USB host controller broadcasts tokens on the bus and a device that detects a match on the address in the token responds by either accepting or sending data to the host. The host also manages USB bus power by supporting suspend/resume operations.

The USB is advantageous in that it does not require the use of specially designed hardware inside the computer; once the appropriate software has been installed, a peripheral can be plugged into the USB port. However, the USB is slower than the PCI bus: the theoretical maximum bandwidth of the USB is 12 Mbps (1.5 Mbps), as compared with 133 MBps for the PCI bus.

U.S. Pat. No. 5,969,750 to Hsieh et al. discusses a moving picture camera with a USB interface. The system is for use in video conferencing applications and includes an imaging device which converts moving pictures into a video signal. The system uses a bit rate reduction circuit which reduces the bit rate of the moving picture signal in order to produce a bit-rate reduced video signal having a lower bandwidth. However, the Hsieh et al. system is generally ill-suited to applications in the dental industry for a number of reasons.

First, unlike video conferencing, dentistry requires full motion video; that is, for a camera to be effective in dental applications, continuous and seamless video is typically required. Second, unlike video conferencing, and as mentioned above, dental cameras require a light source in order to provide illumination to effectively view the inside of a patient's mouth. The light source typically consumes 5 to 50 Watts, which is considerably more than the 2.5 Watts that is commonly offered by the USB and similar ports. In fact, most dental cameras provide illumination via flexible fiber optics which have power requirements greater than can be met by existing computer port technology, therefore necessitating an external power supply. Often, the power supply, illumination, and additional electronics are housed in an external base station. This base station can be cumbersome, complex, and limiting to the camera's portability.

Thus, there is a need for a dental camera which overcomes the above-mentioned problems of prior art systems.

### SUMMARY OF THE INVENTION

Accordingly, it is an object of this invention to provide an intra-oral dental camera system which has a digital output and which can be coupled directly and independently to a computer. The dental camera may be plugged directly into a computer by way of a commonly available and accessible digital port. Unlike previous cameras for use in the dental industry, this invention is a camera which has a digital output and which is specifically designed so that it remains suited to dental applications.

The dental camera preferably connects directly to a computer port without requiring an intermediate base station and without requiring the installation of peripheral hardware components. Examples of a digital port which the dental camera can be plugged into include, but are not limited to, the USB (Universal Serial Bus) or PCMCIA port (Personal Computer Memory Card International Association). The invention does not require supplemental power, as its imaging chip and the illuminator's energy needs are relatively modest due to the design described herein. The dental camera transmits video at a rate approaching 30 frames per second without delay.

It is therefore an object of this invention to provide an intra-oral dental camera having a more simplistic scheme than prior art cameras and that outputs a digital signal, which does not require specialized hardware components, a cumbersome base station, and numerous cords for data and power. In this way, a simpler mechanism of integrating a dental camera with a computer is achieved. In providing a camera suited for dental applications wherein the signal leaving the dental camera is in a compressed digital format, the present invention reduces the risk of losses that would otherwise occur in the cable and in the specialized hardware.

Since a dental camera also carries with it the additional complexity of requiring power for illumination, it is also an object of this invention to provide a simple digital dental camera which operates within the power budget offered by existing port technology such as, but not limited to, the USB. While most prior art dental cameras achieve illumination by way of flexible fiber optics, this invention utilizes a low power light source such as LEDs, thus eliminating the need for an external power supply.

The dental camera system utilizes a port such as the USB and achieves full motion video through a small unit integral to the camera handpiece. This unit outputs a digital signal, contains data compression circuitry, and effects port management within its slim profile.

A digital dental camera that plugs directly into a computer as taught by this invention offers several advantages. First, the camera outputs a clean digital signal. Second, installation of the camera is simple, as there are no computer cards to install and there is only one cable to connect. Third, there are fewer parts to break and fewer cards of the overall system to manage. Furthermore, the dental camera does not have to be operated in close proximity to a power supply; in fact, if the practitioner is using a laptop computer with a battery supply, he or she can utilize the system without power anywhere in the vicinity.

The invention in one embodiment provides an intra-oral dental camera, comprising a handpiece having a plurality of LEDs to illuminate a subject, an image sensor that generates an analog signal representing an intra-oral video image, an analog-to-digital converter that converts the analog signal into a digital signal, and a video compression circuit that compresses compressing the digital signal. A cable is connected to the handpiece that receives the compressed digital signal from the handpiece, provides the compressed digital signal to a digital port on an image processing unit and provides power from the image processing unit to the handpiece to drive the LEDs. The digital port may be a Universal Serial Bus port. The cable may be a flexible shielded cable. The image sensor may be a charge-coupled device or an active pixel sensor array.

The invention in another embodiment provides an intra-oral dental camera, comprising a handpiece having means for generating an analog signal representing a video image, means for converting the analog signal into a digital signal, and means for compressing the digital signal. Conduit means is connected to the handpiece for receiving the compressed digital signal from the handpiece, providing the compressed digital signal to a digital port on an image processing unit and providing power from the image processing unit to the handpiece. The handpiece further comprises means for illuminating a subject. The illuminating means may be a plurality of LEDs. The conduit means may be a flexible shielded cable.

The invention in another embodiment provides an intra-oral dental camera system, comprising a handpiece having a plurality of LEDs to illuminate a subject, an image sensor that generates an analog signal representing an intra-oral video image, an analog-to-digital converter that converts the analog signal into a digital signal, and a video compression circuit that compresses the digital signal. A cable is connected to the handpiece that receives the compressed digital signal from the handpiece. An image processing unit has a digital port that receives the compressed digital signal from the cable, and that provides power to the handpiece through the cable to drive the LEDs.

The invention in another embodiment provides an intra-oral dental camera system, comprising a handpiece having means for generating an analog signal representing a video image, means for converting the analog signal into a digital signal, and means for compressing the digital signal. Conduit means is connected to the handpiece for receiving the compressed digital signal from the handpiece. An image processing unit has a digital port for receiving the compressed digital signal from the cable, and for providing power to the handpiece through the cable. The handpiece further comprises means for illuminating a subject. The illuminating means may be a plurality of LEDs.

The invention in another embodiment provides an intra-oral dental camera, comprising a handpiece having a plurality of LEDs to illuminate a subject, and an image sensor having an analog-to-digital converter and a video compression circuit, to generate a compressed digital signal representing an intra-oral video image. A cable is connected to the handpiece that receives the compressed digital signal from the handpiece, provides the compressed digital signal to a digital port on an image processing unit and provides power from the image processing unit to the handpiece to drive the LEDs. The image sensor may be, for example, an active pixel sensor array.

The invention in another embodiment provides an intra-oral dental camera system, comprising a handpiece having a plurality of LEDs to illuminate a subject and an image sensor that generates a compressed digital signal representing an intra-oral video image. A cable is connected to the handpiece that receives the compressed digital signal from the handpiece. An image processing unit is provided, having a digital port that receives the compressed digital signal from the cable, and that provides power to the handpiece through the cable to drive the LEDs.

The invention in another embodiment comprises an intra-oral dental camera, comprising a handpiece having a plurality of LEDs to illuminate a subject, an image sensor having an analog-to-digital converter that generate a digital signal representing an intra-oral video image, and a video compression circuit that compresses the digital signal. A cable is connected to the handpiece that receives the compressed digital signal from the handpiece, provides the compressed digital signal to a digital port on an image processing unit, and provides power from the image processing unit to the handpiece to drive the LEDs.

The invention will next be described in connection with certain exemplary embodiments; however, it should be clear to those skilled in the art that various modifications, additions, and subtractions can be made without departing from the spirit or scope of the claims.

### BRIEF DESCRIPTION OF THE DRAWINGS

FIG. 1 illustrates a computer-cable-camera system according to one embodiment of this invention;

FIG. 2 illustrates a wiring schematic of an LED configuration of the dental camera according to one embodiment;

FIG. 3 is a functional block diagram of the dental camera according to one embodiment;

FIG. 4A illustrates a computer-cable-camera system according to another embodiment of the invention, which uses a CMOS APS chip having an ADC and video compression circuitry located thereon; and

FIG. 4B illustrates a computer-cable-camera system according to another embodiment of the invention, which uses a CMOS APS chip having an on-chip ADC.

### DETAILED DESCRIPTION OF THE INVENTION

As mentioned above, this invention provides an intra-oral dental camera system having a digital output which communicates directly with a computer. The dental camera system utilizes a port such as the USB and achieves full motion video through a small unit integral to the camera handpiece. This unit includes data compression circuitry, outputs a digital signal, and effects port management (such as USB port management) within its slim profile.

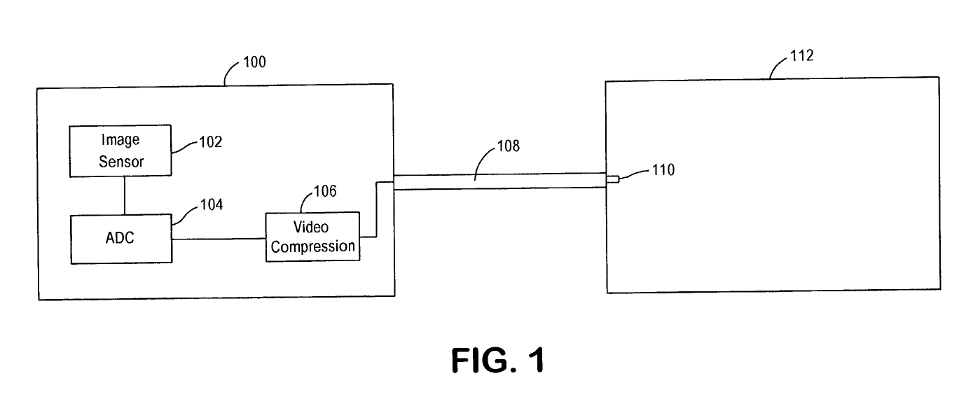

FIG. 1 shows a digital dental camera system in accordance with one embodiment of this invention. A handpiece 100 includes an imaging sensor 102, such as a charge-coupled device (CCD), which generates an analog signal representing an image. The analog signal is fed into an ADC 104 where it is converted into a digital signal and then compressed by video compression circuitry 106. The compressed digital signal is then fed through a conduit 108 to a digital port 110 of a computer 112. The conduit 108 may be a flexible shielded cable. The digital port 108 may be a USB port. The digital dental camera of FIG. 1 achieves illumination by way of a low power light source, such as light emitting diodes (LEDs), which can be powered simply by the power commonly offered by the USB and similar ports. Power may be supplied from the USB to the handpiece via the conduit 108. In this way the invention eliminates the need for an external power supply.

As can be seen from this description, the digital dental camera is attached directly to a computer via a single cable independent of supplemental power or peripheral components. A digital compressed signal local to the camera, careful power management, and an efficient light source together allow for this novel and simple design.

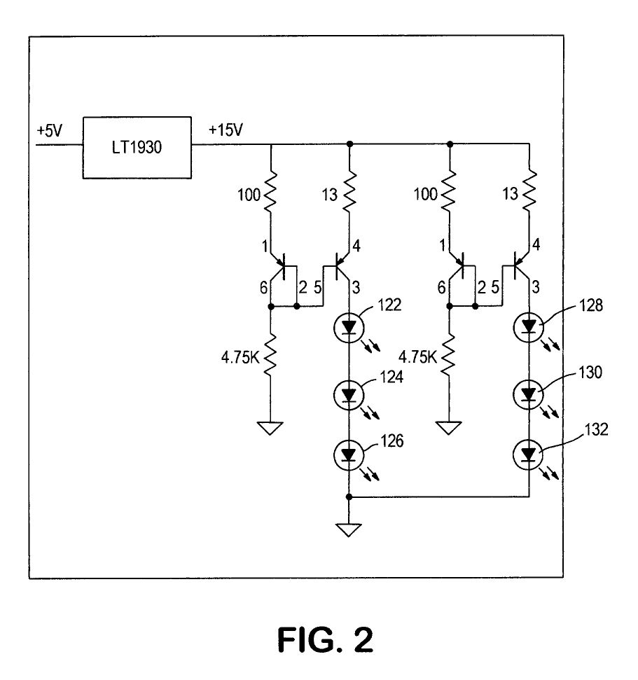

The power management features of the invention will now be described in more detail. The USB, for example, can supply a maximum of 500 mA at 5 V for 2.5 Watts of power. The power management of peripherals attached directly to a computer must therefore be careful and deliberate. Since the greatest draw of resources in a dental camera is the light source, utilizing a low power source such as LEDs as taught by the present invention is essential. A white LED typically consumes 20 mA with a forward voltage drop of 3.6 V or 72 mWatts. In the embodiment described herein, a total of six LEDs are utilized for a total power consumption of 432 mWatts. Compared to fiber optic light or incandescent bulb sources that typically consume 50 Watts or 5 Watts, respectively, this strategy is a major improvement. A high efficiency boost converter such as LT 1930 available from Linear Technology jumps the supply voltage to 15 V at 50 mA so that it may be distributed to the various components. FIG. 2 illustrates a wiring schematic of the LED configuration according to one embodiment. The embodiment shown in FIG. 2 uses six LEDs 122, 124, 126, 128, 130, and 132, although it is to be understood that the invention is not limited to the preferred embodiments.

Furthermore, in order to operate the camera with limited available power, it is advisable to utilize a highly integrated and power efficient method to control the CCD, compress the data, and communicate with the USB port. For example, the video compression circuitry can be combined in a unit that handles USB management and color processing (such as Phillips, SAA8116).

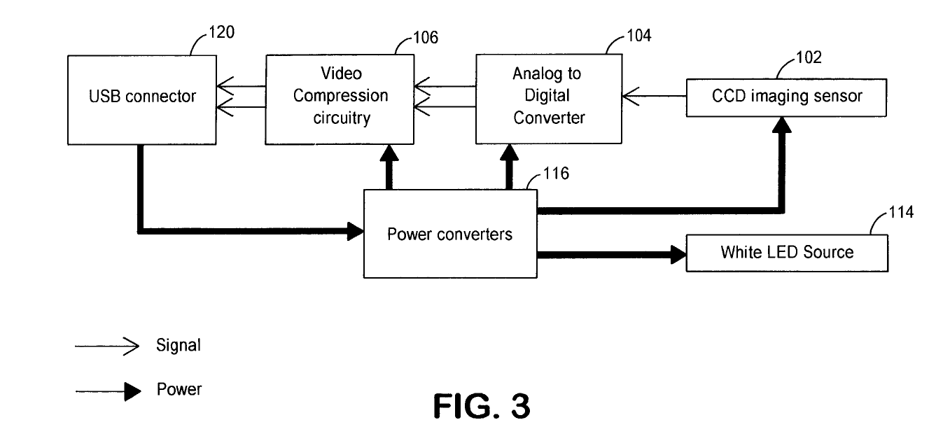

FIG. 3 shows a functional block diagram of the dental camera system according to one embodiment. In FIG. 3, the signal representing the image flows from the imaging sensor 102, in this case a CCD, to the ADC 104, to the video compression circuitry 106, and to the connector to a digital port of a computer, in this case USB connector 120. Power converters 116 take the power supplied by the USB and convert the power to the different voltages needed by the different parts of the camera, e.g., the imaging sensor 102, A/D converter 104, video compression circuitry 106, and white LED source 114. As can be seen from FIG. 3, then, the dental camera is connected to a computer using a readily available port, such as the USB, which is capable of supporting both power and data transfer by way of a flexible cable to the dental camera. The computer may be portable, desktop, notepad, or any other device having a central processing unit (CPU) which is capable of acquiring and displaying an image. The wire is preferably a flexible shielded cable, as is well known in the field.

In one embodiment, the system utilizes USB 1.0 technology and the dental camera is integrated with a small unit including an A/D converter and a compression chip (such as those made by Philips). The unit also carries out USB management. In this embodiment, the image is fed along the cable, from the dental camera to the USB port, in a compressed digital format. The image is decompressed by, for example, Direct X firmware installed on the computer. The Direct X firmware also enables a freeze-frame mode. Those skilled in the art will recognize that, depending on the overall pixel count, the data compression may be either lossy or lossless, and can be mediated by software and/or hardware components. In any case, the preferred embodiment enables an effective data transmission rate of 30 frames per second. Other transmission rates, such as those compatible with PAL or SECAM, could alternatively be employed.

In another embodiment, the invention utilizes USB 2.0 technology, and data compression may not be required. Alternative embodiments utilizing other digital ports that can provide both power and data transfer would be apparent to those skilled in the art.

As explained above, power management is also an important feature of this invention. Designing a dental camera to integrate with a computer port necessitates careful power management. The USB, for example, provides ample current to the camera power supply in the preferred embodiment. Although illumination is provided by a low-power light source such as white LED's as explained above, other low-power light sources may be implemented. Furthermore, a CCD imaging sensor is used to capture the light signal in the above-described embodiments; however, other CMOS or CID solid state imaging devices could be utilized, taking into account the power budget.

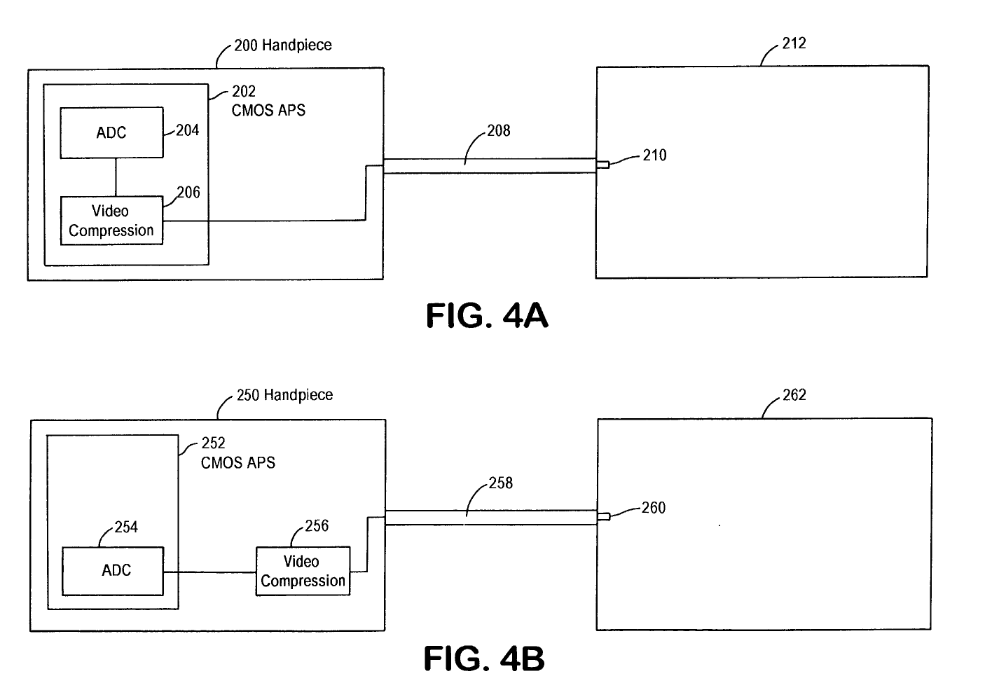

For example, another image sensor which could be used is a CMOS APS (active pixel sensor) array, such as for example of the type described in U.S. Pat. No. 5,912,942, hereby incorporated by reference. CMOS APS image sensors typically consume less power than CCD image sensors, and are easier to manufacture, among other differences. FIG. 4A illustrates a computer-cable-camera system according to another embodiment of the invention, which uses a CMOS APS having an on-chip ADC and on-chip video compression circuitry. Other circuitry could be placed on the chip as well.

In FIG. 4A, a handpiece 200 includes a CMOS APS image sensor 202, which outputs a compressed digital signal representing an image by way of its on-chip ADC 204 and on-chip video compression circuitry 206. The compressed digital signal is then fed through a conduit 208 to a digital port 210 of a computer 212, which may be a USB port, for example. The digital dental camera of FIG. 4A achieves illumination by way of a low power light source, such as LEDs. In FIG. 4B, the video compression circuitry 256 is not located on the CMOS APS chip.

While the invention has been particularly shown and described with respect to preferred embodiments thereof, it will be understood by those skilled in the art that changes in form and details may be made therein without departing from the scope and spirit of the invention.

Having described the invention, what is claimed as new and secured by Letters Patent is:

1. An intra-oral dental camera, comprising:
a handpiece having a plurality of LEDs to illuminate a subject, an image sensor that generates an analog signal representing an intra-oral video image, an analog-to-digital converter that converts the analog signal into a digital signal, and a video compression circuit that compresses compressing the digital signal; and
a cable connected to the handpiece that receives the compressed digital signal from the handpiece, provides the compressed digital signal to a digital port on an image processing unit and provides power from the image processing unit to the handpiece to drive the LEDs.

2. The intra-oral dental camera as set forth in claim 1, wherein the digital port is a Universal Serial Bus port.

3. The intra-oral dental camera as set forth in claim 1, wherein the cable is a flexible shielded cable.

4. The intra-oral dental camera as set forth in claim 1, wherein the image sensor comprises a charge-coupled device.

5. The intra-oral dental camera as set forth in claim 1, wherein the image sensor comprises an active pixel sensor array.

6. An intra-oral dental camera, comprising:
a handpiece having means for generating an analog signal representing a video image, means for converting the analog signal into a digital signal, and means for compressing the digital signal; and
conduit means connected to the handpiece for receiving the compressed digital signal from the handpiece, providing the compressed digital signal to a digital port on an image processing unit and providing power from the image processing unit to the handpiece.

7. The intra-oral dental camera as set forth in claim 6, wherein the handpiece further comprises means for illuminating a subject.

8. The intra-oral dental camera as set forth in claim 7, wherein the illuminating means comprises a plurality of LEDs.

9. The intra-oral dental camera as set forth in claim 6, wherein the digital port is a Universal Serial Bus port.

10. The intra-oral dental camera as set forth in claim 6, wherein the conduit means is a flexible shielded cable.

11. An intra-oral dental camera system, comprising:
a handpiece having a plurality of LEDs to illuminate a subject, an image sensor that generates an analog signal representing an intra-oral video image, an analog-to-digital converter that converts the analog signal into a digital signal, and a video compression circuit that compresses the digital signal;
a cable connected to the handpiece that receives the compressed digital signal from the handpiece; and
an image processing unit having a digital port that receives the compressed digital signal from the cable, and that provides power to the handpiece through the cable to drive the LEDs.

12. The intra-oral dental camera as set forth in claim 11, wherein the digital port is a Universal Serial Bus.

13. The intra-oral dental camera as set forth in claim 11, wherein the cable is a flexible shielded cable.

14. An intra-oral dental camera system, comprising:
a handpiece having means for generating an analog signal representing a video image, means for converting the analog signal into a digital signal, and means for compressing the digital signal;
conduit means connected to the handpiece for receiving the compressed digital signal from the handpiece; and
an image processing unit having a digital port for receiving the compressed digital signal from the cable, and for providing power to the handpiece through the cable.

15. The intra-oral dental camera as set forth in claim 14, wherein the handpiece further comprises means for illuminating a subject.

16. The intra-oral dental camera as set forth in claim 15, wherein the illuminating means comprises a plurality of LEDs.

17. The intra-oral dental camera as set forth in claim 15, wherein the digital port is a Universal Serial Bus port.

18. The intra-oral dental camera as set forth in claim 15, wherein the conduit means is a flexible shielded cable.

19. An intra-oral dental camera, comprising:
a handpiece having a plurality of LEDs to illuminate a subject and an image sensor having an analog-to-digital converter and a video compression circuit to generate a compressed digital signal representing an intra-oral video image; and
a cable connected to the handpiece that receives the compressed digital signal from the handpiece, provides the compressed digital signal to a digital port on an image processing unit and provides power from the image processing unit to the handpiece to drive the LEDs.

20. The intra-oral dental camera as set forth in claim 19, wherein the digital port is a Universal Serial Bus port.

21. The intra-oral dental camera as set forth in claim 19, wherein the image sensor comprises an active pixel sensor array.

22. An intra-oral dental camera system, comprising:
a handpiece having a plurality of LEDs to illuminate a subject and an image sensor that generates a compressed digital signal representing an intra-oral video image;
a cable connected to the handpiece that receives the compressed digital signal from the handpiece; and
an image processing unit having a digital port that receives the compressed digital signal from the cable, and that provides power to the handpiece through the cable to drive the LEDs.

23. The intra-oral dental camera as set forth in claim 22, wherein the digital port is a Universal Serial Bus.

24. The intra-oral dental camera as set forth in claim 22, wherein the image sensor comprises an active pixel sensor array.

25. An intra-oral dental camera, comprising:
a handpiece having a plurality of LEDs to illuminate a subject, an image sensor having an analog-to-digital converter that generate a digital signal representing an intra-oral video image, and a video compression circuit that compresses the digital signal; and
a cable connected to the handpiece that receives the compressed digital signal from the handpiece, provides the compressed digital signal to a digital port on an image processing unit and provides power from the image processing unit to the handpiece to drive the LEDs.

26. The intra-oral dental camera as set forth in claim 25, wherein the digital port is a Universal Serial Bus port.

27. The intra-oral dental camera as set forth in claim 25, wherein the image sensor comprises an active pixel sensor array.
